(19) United States
(12) Patent Application Publication
(10) Pub. No.: US 2006/0051111 A1
(43) Pub. Date: Mar. 9, 2006

(54) Condenser type fixing and image forming apparatuses

(76) Inventors: Kazuhito Kishi, Kanagawa-ken (JP); Susumu Matsusaka, Kanagawa-ken (JP); Yasuhisa Kato, Kanagawa-ken (JP); Akiyasu Amita, Kanagawa-ken (JP); Masami Okamoto, Kanagawa-ken (JP); Hiromasa Takagi, Tokyo (JP); Yasutada Tsukioka, Chiba-ken (JP); Ryuichi Kikegawa, Miyagi-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/220,682

(22) Filed: Sep. 8, 2005

(30) Foreign Application Priority Data
Sep. 9, 2004 (JP) 2004-262590

(51) Int. Cl. G03G 15/20

(52) U.S. Cl. 399/33

(57) ABSTRACT

A fixing apparatus includes an electrical condenser charged by a commercial power source, a heat generating member that generates heat when the electrical condenser supplies power, and a fixing device that is heated by the heat generating member and fixes an image onto a recording medium. A temperature switch is activated when temperature of the fixing member reaches a prescribed abnormal level. A power supply circuit is provided to convey the power from the electrical condenser to the heat generating member. A cutting off device is provided to cut off the power supply circuit when the temperature switch is operated.

### CROSS REFERRENCE TO RELATED APPLICATION

This application claims priority under 35 USC §119 to Japanese Patent Application No. 2004-262590 filed on Sep. 9, 2004, the entire contents of which are herein incorporating by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a fixing apparatus and an image forming system employing the fixing apparatus.

2. Discussion of the Background Art

It is well known that a fixing apparatus used in an image forming system, such as a copier, a printer, a facsimile, etc., generally employs a secondary battery that is charged by a commercial AC power source, a heat applying section that is supplied with electric power by the secondary battery, and a fixing member that applies heat through a heat applying section so as to fix an image onto a recording medium. Such a fixing apparatus sometimes employs a thermostat (TM) in a power supply circuit that supplies power to a heater included in the fixing member as discussed in Japanese Patent Application Laid Open No. 2001-92302. As another type of a fixing apparatus, an electrical condenser supplies power to a heater.

In such fixing apparatuses, a large amount of current (DC) simultaneously flows through a switch in the electric power supply circuit, when large electric power is supplied to the heat applying section from the secondary battery. Further, it is significantly difficult to arrange a thermostat(TM), which serves as a safety apparatus when temperature abnormally increases, within a circuit driven by such a large electric power.

Specifically, since the thermostat adapted to a large DC power is significantly large in size, it cannot be arranged within the fixing apparatus or unit. When being forcibly arranged, a responding speed is too slow to use it as a safety device for an apparatus that attempts to quickly increase temperature. Accordingly, it cannot maintain safety of the apparatus.

The reason why there exists no downsized thermostat capable of adapting to the large DC power is that when a DC is continuously supplied for a long time, it becomes difficult for a switch to operate due to migration, or is possibly deposited due to electro discharging even being operable. Such a problem is not raised when an AC is flown.

### SUMMARY OF THE INVENTION

Accordingly, an object of the present invention is to address and resolve such and other problems and provide a new and novel fixing apparatus. Such a new and noble fixing apparatus includes an electrical condenser charged by a commercial power source, a heat generating member that generates heat when the electrical condenser supplies power, and a fixing device that is heated by the heat generating member and fixes an image onto a recording medium. A temperature switch is activated when temperature of the fixing member reaches a prescribed abnormal level. A power supply circuit is provided to convey the power from the electrical condenser to the heat generating member. Further, a cutting off device is provided to cut off the power supply circuit when the temperature switch is operated.

In another embodiment, a first heat generating member is provided to generate heat when AC power is supplied by a commercial power source. A second heat generating member is provided to generate heat when the electrical condenser supplies DC power. A fixing member is heated by the first and second heat generating members and heats and fixes an image onto a recording medium. A first power supply circuit is provided to convey AC power from the commercial power source to the first heat generating member. A second power supply circuit is provided to convey DC power from the electrical condenser to the second heat generating member. Further, a first cutting off device is provided to cut off the first power supply circuit when the temperature switch is operated.

In yet another embodiment, a second cutting off device is provided to cut off the second power supply circuit when the temperature switch is operated.

In yet another embodiment, a closed circuit is provided and includes the cutting off device and a power source connected to the temperature switch. Power of the power source is smaller than that of the electrical condenser.

In yet another embodiment, the temperature switch includes one of a temperature fuse and a thermostat (TM). The cutting off device includes a relay arranged between one of the commercial power source and the electrical condenser and the heat generating member. The relay is activated when one of the temperature fuse and thermostat is operated.

In yet another embodiment, the smaller power source provides one of direct and alternate currents.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates an exemplary image forming system that employs an exemplary fixing apparatus according to one embodiment of the present invention;

FIG. 2 illustrates an exemplary fixing apparatus according to one embodiment of the present invention;

FIG. 3 illustrates an exemplary fixing apparatus according to one embodiment of the present invention;

FIG. 4 illustrates an exemplary circuit of the fixing apparatus shown in FIGS. 2 and 3;

FIGS. 5A and 5B each illustrates exemplary temperature transition when main and auxiliary power sources are controlled;

FIG. 6 illustrates an exemplary power supply control manner that enables a fixing member employing a thin roller to quickly increase temperature without dropping;

FIG. 7 illustrates an exemplary thermostat;

FIG. 8 illustrates a conventional circuit included in a fixing apparatus; and

FIG. 9 illustrates an exemplary circuit of a fixing apparatus according to one embodiment of the present invention.

### DESCRIPTION OF THE PREFERRED EMBODIMENTS

Referring now to the drawings, wherein like reference numerals designate identical or corresponding parts throughout the several views.

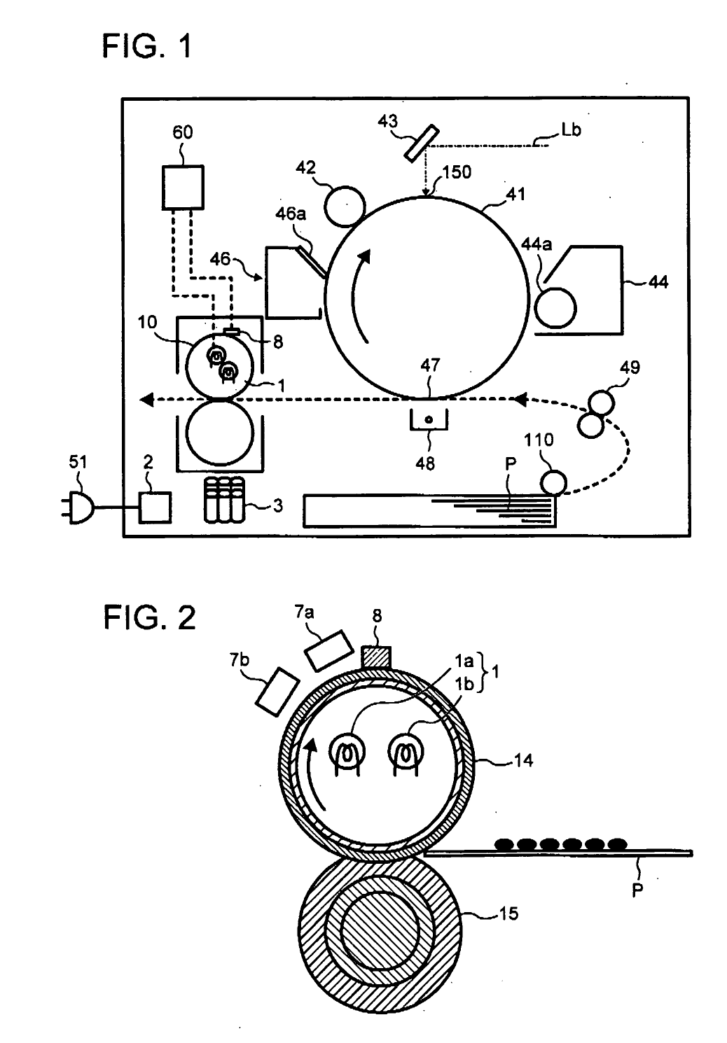

Referring now to the drawing, wherein like reference numerals designate identical or corresponding parts throughout several views, in particular to FIG. 1, an exemplary image forming system is illustrated. As shown, a photoconductive member 41 as an image bearer having a drum shape rotates in a prescribed direction as shown by an arrow. A discharge apparatus 42 formed from a charge roller, a mirror 43 partially forming an exposure device, a developing apparatus 44 having a developing roller 44a, a transfer apparatus 48 that transfers a visualized image onto a transfer sheet serving as a recording member P, and a cleaning apparatus 46 having a blade 46a that sliding contacts the surface of the photo-conductive member 41 etc., are provided around the photo-conductive member 41 in the rotational direction. The photoconductive member 41 is scanned by an exposure light Lb through a mirror 43 at an exposure section 150 between the discharge apparatus 42 and the developing roller 44a.

The transfer apparatus 48 opposes the lower surface of the photoconductive member 41 at a transfer section 47. A pair of registration rollers 49 are arranged upstream of the transfer section 47 in the rotational direction of the photoconductive member 41. A recording member P accommodated in a sheet-feeding tray (not shown) is launched by a sheet-feeding roller 110 toward the pair of registration rollers 49 while being guided by a conveyance guide (not shown). A fixing apparatus 10 is arranged downstream of the transfer section 47.

An exemplary image formation is in the below described manner. First, the photoconductive member 41 starts rotating. The discharge apparatus 42 uniformly applies charges onto the photoconductive member 41 in the dark during the rotation of the photoconductive member 41. The exposure light Lb is emitted and scans the exposure section 150, thereby forming a latent image corresponding to an image to be formed. The latent image moves as the photoconductive member 41 rotates to the developing apparatus 44 and is developed with toner, thereby being visualized as a toner image.

Simultaneously, as mentioned above, the recording member P on the sheet feeding tray is fed by the sheet feeding roller 110, and is temporally stopped at the pair of registration roller 49 via a conveyance path shown by a dotted line to be fed in synchronism with a toner image carried on the photoconductive member 41 at the transfer section 47.

The registration roller 49 then rotates at a preferable time and feeds the recording member P stopping there toward the transfer section 47. Then, the toner image is transferred onto the recording member P by the transfer apparatus 48 in an electric field.

The recording member P carrying the toner image formed in an image formation section around the photoconductive member 41 is then fed toward the fixing apparatus 10. The toner image is fixed to the recording member P during passage through the fixing apparatus 10, and is ejected onto an ejection section (not shown).

The toner left on the photoconductive member 41 arrives at the cleaning apparatus 46 as the photoconductive member 41 rotates and is cleaned during passage of the cleaning apparatus 46. Thus, the photoconductive member 41 becomes ready for the next image formation.

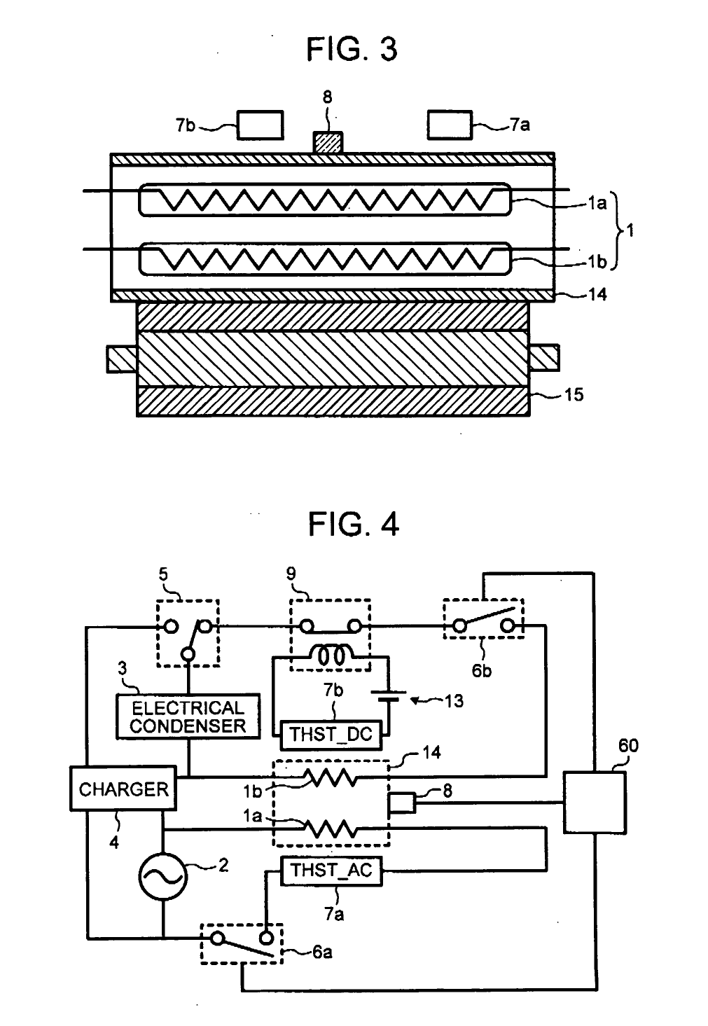

As shown in FIGS. 2 to 4, the fixing apparatus 10 includes a fixing member 14 having a heat applying section 1, a pressure applying member 15, and the fixing section temperature-detecting device 8. As shown in FIG. 4, the fixing apparatus 10 further includes a control device 60 that controls power to be supplied from the auxiliary power source 3(?) to the fixing apparatus 10 in accordance with temperature information transmitted from the fixing section temperature detecting device 8.

The fixing section temperature-detecting device 8 is arranged in the vicinity of the center of the fixing section in the longitudinal direction so as to detect every size of the recording members P. The fixing section temperature detecting device 8 is formed from one of a thermistor, a thermocouple, a ultraviolet light temperature detecting apparatus and the like so as to transmit temperature information to the control device 60. The control device 60 at least controls starting, stopping, and adjusting an amount of power supplied to the heat-applying device 1 based upon temperature information obtained from the fixing section temperature-detecting device 8. Further, as shown in FIG. 4, the fixing apparatus 10 includes a switch to be turned on and off as a power control device (e.g. AC use 6a, DC use 6b) based upon an instruction of the control device 60. Further, supposing a case of out of control of a system, a safety apparatus is provided to terminate supplying power and maintain safety in such a situation by cutting off a circuit using thermostats 7a and 7b (THST_AC and THST_DC), and a relay apparatus 9 and the like. Details of the apparatus will be mentioned later.

A main power source 2 is provided to supply power to various units arranged at sections of an image forming system while obtaining a power from a commercial power source. Similar to a typical instrument, power can be supplied to the respective units of the image forming system when a plug of a power source line is inserted into a plug outlet of the commercial power source.

An auxiliary power source 3 is provided and includes an electrical condenser, such as an electric double layer capacitor, an electric double layer condenser, etc. The auxiliary power source 3 condenses power discharged by the main power source 2, and supplies the power in addition to that supplied from the main power source 2. Thereby, a large power can be supplied to the image forming system. Every power source, such as secondary battery types of Li ion and nickel hydrogen, a dummy capacity capacitor that utilizes oxidation-reduction, etc., can be used to store electricity beside the electric double layer capacitor as far as they output a DC.

As mentioned above, the heat applying section 1 includes a plurality of AC and DC heat generating members 1a and 1b (hereinafter referred to as main and auxiliary heat generating members). The fixing apparatus 14 includes a charger 4, a charge-discharge switching device 5, a main power control device 6a that controls power supplying from the main power source 2, and an auxiliary power control device 6b that controls power supplying from the auxiliary power source 3.

The main heat generation member 1a generates heat when a current is flown to a filament formed in a glass tube thereof. A halogen heater is preferably employed in each of AC and DC heat generating members 1a and 1b. However, an induction heating device and a ceramic heater can be employed beside the halogen heater.

One halogen heater generating 1200 W when 100V is applied is utilized for the main heat generating member 1a. However, two heaters can be employed to heat both ends of the fixing member 14 in an axial direction and a central portion.

The auxiliary heat generation member 1b generates heat upon receiving power supplied from the auxiliary power source 3 and similarly heats the fixing member 14. However, a halogen heater generating 600 W when 50V is applied can be employed. A halogen heater generating 700 w when 100V is applied can be utilized, to heat both side ends distanced by about 310 mm so as to cover an A4 size (JIS) sheet when it is laterally fed.

A roller base member of the fixing member 14 is preferably made of metal such as aluminum in view of durability and anti-deformation considering application of pressure. A releasing layer is preferably formed on the surface of the roller so as to suppress sticking of toner thereto. Black processing is preferably applied to the inner surface of the roller so as to efficiently absorb heat of the halogen heater. Further, a belt type-fixing mechanism (not shown) can be employed while forming a nip instead of the roller.

The pressure-applying member 15 is formed from a core metal and an elastic layer such as rubber etc., wrapping the metal core to form a nip, in cooperation with the fixing member 14. A non-fixed toner image formed on a recording member P is fixed thereon by both heat and pressure when being fed through the nip section. A heat-generating member (not shown) can be employed in the pressure-applying member 15 to generate heat upon receiving power from the auxiliary power source 3. A pressure roller having a foam layer can be employed for the pressure member 15 to form a nip in cooperation with the fixing member 14. In such a situation, since heat of the fixing member 14 is difficult to be conveyed to the pressure roller owing to heat insulation effect of the foam layer, temperature of the fixing member 14 can quickly increases.

The auxiliary power source 3 charges and supplies electric power to the auxiliary heat generation member 1b. The auxiliary power source 3 can previously store power supplied from the main power source 2 after the charger 4 adjusts the voltage of the power. Further, an auxiliary power can be supply to the heat applying section 1 (i.e., the auxiliary heat generation member 1b) at an optional time under control of a charge/discharge switching device 5.

Specifically, the main power source 2 obtains power from the commercial power source through the plug 51 and the plug outlet, and supplies respective units of the image forming system therewith. A current is sometimes restricted to about 15 Ampere and 100 Voltage, and 1500 Watt is sometimes supplied from the main power source 2 as the maximum power depending upon a country. Further, functions, such as voltage adjustment, rectification from alternate to direct currents, voltage stabilization, etc., can be included in the main power source 2.

A main power control device 6a is provided to control power supplied to the fixing member 14 from the main power source 2, and executes a switching operation to turn on and off in accordance with an instruction from the control device 60 having a CPU, as well as temperature information obtained from the fixing section temperature detecting device 8.

Further, an auxiliary power control device 6b is provided to control power to be supplied to the fixing member 14 from the auxiliary power source 3 by turning on and off in accordance with temperature information of the fixing section temperature detecting device 8 as the main power control device 6a.

As mentioned above, the auxiliary power source 3 is formed by connecting a plurality of capacitor cells formed from electrical double layer capacitors, and is enabled to supply power charged and stored by the main power source 2 to the heating section 1 when relatively larger power is needed to be supplied such as when a system starts up, sheets are continuously fed, etc., in addition to power from the main power source 2. Thus, power larger than that supplied by only the main power source 2 can be supplied to the image forming system.

Such an auxiliary power source 3 can employ an electric storage device that is formed in a module of 100 volts by serially connecting forty capacitor cells each having performances of a voltage about 2.5 Volt, about 800 F of an electrostatic capacity, an internal resistance of less than about 5 mΩ, a diameter of about 35 mm, and a length of about 100 mm. In order to balance voltages among respective cells when serially connecting those, a voltage balancing circuit (not shown) is employed. As a result, activity can be maintained stably for a long time period. Further, when an internal resistance of the cell is less than 5 mΩ and a larger current than 20 A flows when an image forming system starts, a voltage between terminals of the auxiliary power source 3 decreases by an amount less than that decreased when a lithium or nickel hydrogen battery or the like is used. Further, since a value of the capacitor is smaller than average, a large power can be obtained by less number of capacitor cells. Thus, it is advantageous in view of size and cost.

Thus, if the electric double layer capacitor, i.e., a large capacity chargeable (dischargeable) condenser, is utilized as an auxiliary power source 3, prompt charging and a long life can be advantageously obtained. Because, the electric double layer capacitor does not accompany chemical reaction as different from a secondary battery.

Specifically, when the auxiliary power source employing conventional nickel-cadmium battery is utilized as a secondary battery, a large amount of power can be supplied only by a few times a day at few hours interval, and is inconvenient. Because, from dozens of ten minutes to a few hours is needed even the battery is rapidly charged. To the contrary, when a electric condenser is used as an auxiliary power source, a charging up time period can be shorter, and is charged during absence of printing, i.e., when the main power source has spare power, and thus a number of times of heating with the auxiliary power source can be increased into a practically available level. Because, the condenser can be charged up within from about dozens of ten seconds to about a few minutes.

Since the nickel-cadmium battery should be repeatedly recharged by about 500 to about 1000 times, and has a shorter life when used as an auxiliary battery, it causes a problem of replacement labor. Because, a number of repeating times of charging and discharging is from about five hundred to about one thousand. In contrast, an auxiliary power source using a condenser can repeat charging and discharging by about ten thousand times, and does not deteriorates. Further, since being almost needless of liquid replacement and replenishment, maintenance can be substantially omitted.

Recently, a condenser capable of largely storing electric energy has been developed, and is adapted to an electric car or the like. For example, an electric double layer capacitor developed by Nippon Chemi-Con Corporation has an electrostatic capacity of about 2000 F when 2.5 volts is applied, and is enough to supply power for from a few seconds to dozens of ten seconds. NEC Corporation has realized a condenser named Hyper Capacitor having about 80 F. Further, Japan Electron Optics Laboratory (JEOL) Co., Ltd unveils a technology named a nano gate capacitor having from five to ten times of a withstand voltage of from 3.2 to 3.5 volts and an electronic energy density of from 50 to 75 wh/kg.

As mentioned above, power to be supplied to the heat applying section 1 can be supplied from the main power source 2 to the heat generation member 1a. However, power can simultaneously be supplied from the auxiliary power source 3 to the auxiliary heat generation member 1b. The auxiliary power source 3 can preserve power in cooperation with the charger 4, and supplies the power to the auxiliary heat generation member 1b at an optional time. Due to supplying power to the heat applying section 1 from the auxiliary power source 3 in addition to the main power source 2, larger power can be supplied thereto than that only supplied by the main power source 2.

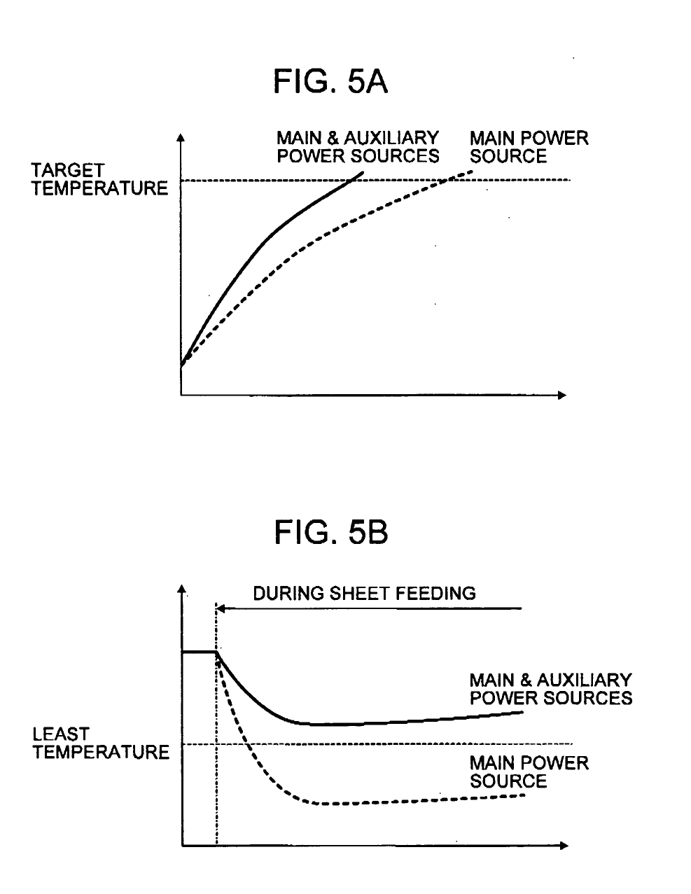

Thus, a temperature increasing time period can be shorter when both main and auxiliary powers are supplied up to when temperature of the heat applying section 1 becomes a predetermined level than when only the main power source is utilized as shown in FIG. 5A. For example, since initialization of respective systems or processes takes a long time period when a main power source is turned on and a image forming system starts up as a first thing in the morning, temperature does not need to quickly increase. Thus, the temperature is increased toward a target level only using the main power source, and is quickly increased by additionally using power from the auxiliary power source when an operation returns from a sleep mode.

Further, as shown in FIG. 5B, even when only the main power source supplies power, a large amount of heat is then absorbed by continuously fed sheets, and temperature accordingly lowers a predetermined lowest level, a temperature dropping amount are reduced by additionally supplying power from the auxiliary power source. Thus, a high-speed image forming system capable of feeding many sheets per unit of time can be provided.

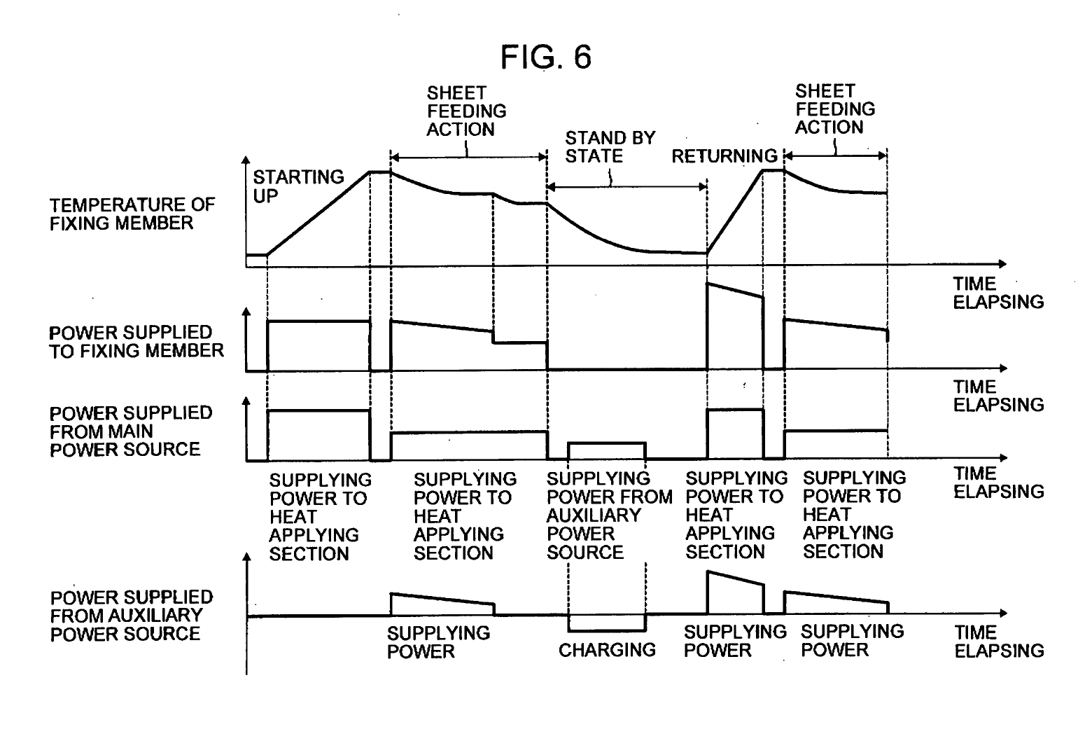

FIG. 6 illustrates such a high-speed image forming system employing a thin roller as a fixing member 14 capable of quickly increasing temperature without dropping thereof. Specifically, in the initial state, an external power source such as a commercial power source, etc., supplies power and charges the auxiliary power source 3 that includes a large capacity condenser such as an quickly chargeable electric double layer capacitor. Since an electric self-discharging amount is small, the condenser can hold enough power through out about one night. Further, since the plug outlet is generally maintained connected, the commercial power source can charge even when a discharged amount lowers the prescribed level. Thus, it is unnecessary to wait for charging up when the main power source is turned on as a first thing in the morning to use an image forming system. However, since power from the auxiliary power source 3 is not used when the image forming system starts up as a first thing in the morning, it takes longer than before temperature increases to a prescribed level than when the image forming system returns while the auxiliary power is supplied in addition to the commercial power source.

When the image forming system starts up, and temperature of the fixing member 14 is to be quickly increased from atmosphere, larger power is totally supplied than when only the main power source 2 supplies if the auxiliary power source 3 supplies power to the heat applying section 1 in addition to the main power source 2. Thus, temperature of the fixing member 14 can be quickly increased. For example, when an aluminum thin roller having a thickness (t) of about 0.7 mm and a diameter of about 40 mm is utilized as a fixing member, and power of about 1200 watt is supplied from the auxiliary power source to the main heat generation member 1a in addition to that from the main power source. Namely, 2400 watt is totally supplied thereto, the temperature increasing time period, which takes 30 seconds when only the main power source is used, can be decreased down to about 15 seconds.

Since the auxiliary power source is formed from a capacitor as mentioned above, power gradually decreases from 1200 watt as a voltage decreases during power supplying. Thus, power becomes a significantly small level when a prescribed time has elapsed. Thus, even if temperature increases up to 500° C. where a sheet almost takes fire, a temperature increasing speed can be decreased. As a result, an image forming system capable of safely and quickly increasing temperature can be provided.

When power is increasingly supplied, the commercial power source supplies power via two routes. Otherwise, a secondary or fuel battery can be employed. However, since these systems continuously supply large power when a temperature is quickly to be increased, a reaction of a safety circuit for these cannot catch up temperature increasing speed. Thus, temperature of the heat applying section 1 becomes too high to avoid catching fire even when the safety circuit works in the worst situation. In contrast, when a capacitor is utilized, the heat generation member stops heating when a prescribed power has been consumed, and temperature automatically stops increasing, even if a system becomes out of control, and thereby power is continuously supplied. Thus, a temperature increasing time period can be safely decreased using the capacitor as a heat source.

When a large number of sheets are fed per unit of time (i.e., at high speed), temperature of a thin roller accordingly decreases because of its thickness. Then, decreasing in temperature can be suppressed by supplying auxiliary power in addition to main power during sheet so as to quickly increase the temperature in view of a preferable usability. According to such a system, since power is utilized for the auxiliary heat generation member during the sheet through, larger power than that supplied from the main power source can be supplied thereto. Since decreasing in temperature just after sheet passage can be suppressed, a thin roller generally capable of forming an image by 60 cpm at most can do so by 75 cpm.

When the image forming system is in an idling state and the main power source 2 has a spare power, the main power source 2 charges the auxiliary power source 3. If a capacitor is used as an auxiliary power source, a charging up time can be decreased down to a few minutes. To even avoid the fixing member 14 from cooling for a few minutes, the auxiliary power source 3 is not needed, or used half way. Thus, the next user does not need waiting for charge completion, thereby the image forming system is convenient.

As mentioned above, an advantage impossible to be obtained by the secondary battery can be obtained for the first time by using the condenser as an auxiliary power source to heat the heat applying section 1.

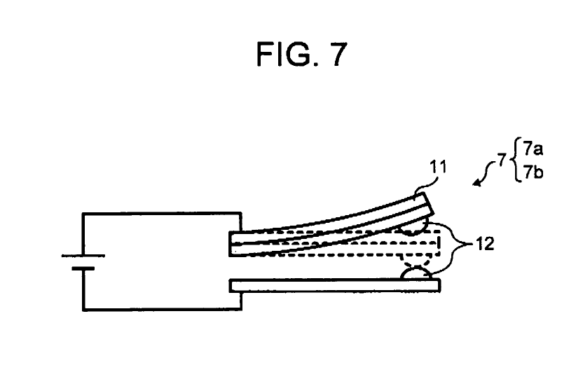

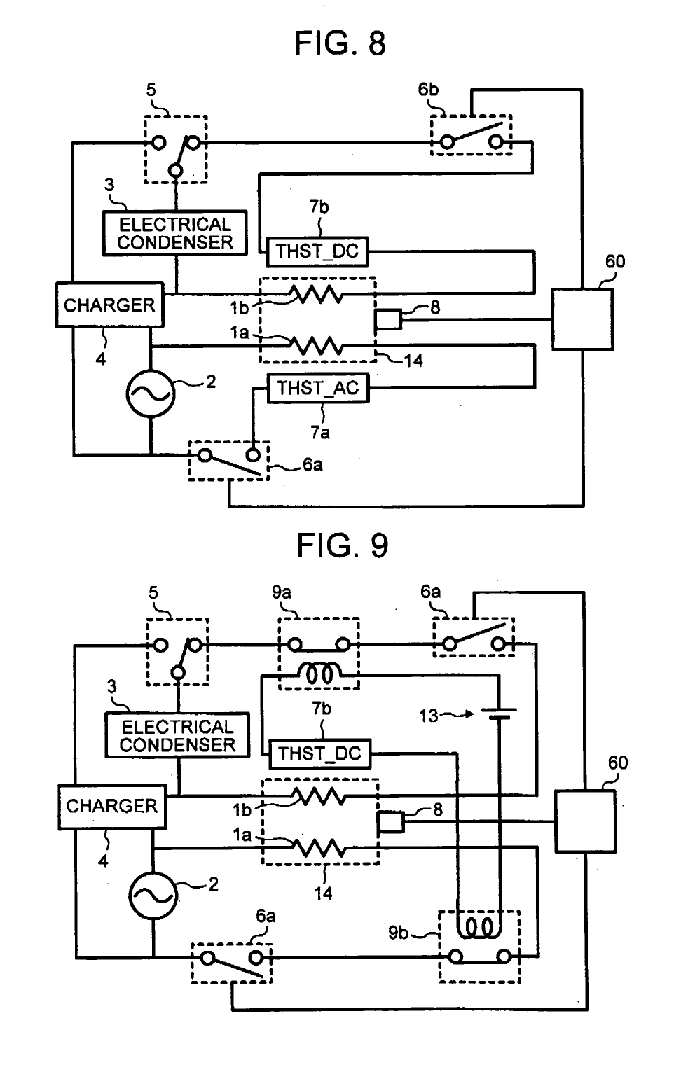

As shown in FIG. 7, another embodiment includes a safety apparatus that maintains safety by cutting off a circuit using a plurality of thermostats (THST_AC, THST_DC) 7a and 7b as well as a relay apparatus 9. However, as shown in FIG. 8, a conventional system is proposed for the purpose of maintaining safety of the auxiliary power source side such that a power supply circuit that supplies power to a DC heater 1b is directly cut off.

However, such a thermostat 7 (7a, 7b) causing a switch 12 either to separate or contact in accordance with deformation of a bimetal 11 as shown in FIG. 7 raises a problem owing to its mechanism. Specifically, power supplied from the auxiliary power source 3 is large and amounts to from a few hundred to a few thousand watt of DC. However, a thermostat for cutting off large power or a downsized temperature fuse does not exist or is difficult to obtain. That is, since a DC current continuously flows in one direction, migration appears on metal of the switch 12, thereby easily sticking thereto. Further, if the switch operates, discharging tends to occur when the switch separates, thereby easily melting. Thus, the switching operation is incredible when practically used. An AC current hardly causes migration even when large power is supplied. Since a zero cross point exists, the switch hardly melts. Thus, a downsized temperature fuse or a thermostat having a diameter of about 2 centimeter can be realized.

Thus, a large thermostat having a five-centimeter square is utilized in any ways. As a result, a fixing apparatus becomes significantly large and the thermostat slowly responds due to large heat capacity. Thus, the thermostat cannot be utilized in a fixing apparatus for the purpose of avoiding sharply increasing and abnormal temperature.

Then, as shown in FIG. 4, a thermostat 7b for auxiliary power source use is not directly connected to an auxiliary power source 3. Specifically, thermostat 7b is arranged in a closed circuit including a low voltage power source 13 having a voltage lower than a rated voltage (e.g. 100 volt) for the auxiliary power source 3. A relay apparatus 9 cuts off power supplied from the auxiliary power source 3 to a DC heater 1b. That is, the above-mentioned problem can be suppressed by indirectly turning off a large power circuit side using a small power DC thermostat. Since the relay apparatus 9 does not need to be arranged in the vicinity of the fixing member 14 as thermostats 7a and 7b, and can handle a large power, a switching problem caused by a large current in the thermostat can be suppressed.

The auxiliary power source use thermostat 7b operates and opens the closed circuit when temperature of the fixing member 14 reaches about 450° C. Thus, the relay circuit apparatus 9 arranged in a high voltage circuit, which supplies power from the auxiliary power source 3 to a DC heater 1b, operates and opens the high voltage circuit. Thus, when a CPU for fixing apparatus control use is out of control and temperature of the fixing apparatus 14 extraordinary increases, power can be stopped being supplied before kindling temperature. As a result, safety expected to a fixing apparatus is improved.

Thus, a DC use thermostat having a diameter of about 2 centimeters operable with a small power can be employed, and a safe, quickly responsible, and highly credible fixing apparatus can be obtained.

Although a low voltage power source for the circuit of the thermostat 7b uses a DC, an AC power source can be used. Since a large power but downsized AC power source use thermostat or a temperature fuse can be employed, a voltage higher than a storage voltage can be used when designing a closed circuit employing an AC.

A second embodiment is now described with reference to FIG. 9. As shown, a relay apparatus 9b is also arranged on an AC heater side to which the main power source 2 supplies power beside relay apparatus 9a on the auxiliary power source side so as to simultaneously cut off power supplied to both the AC and DC heaters 1a and 1b. Since configurations and operations of remaining sections are substantially the same to those in the first embodiment, their explanations are omitted.

Numerous additional modifications and variations of the present invention are possible in light of the above teachings. It is therefore to be understood that within the scope of the appended claims, the present invention may be practiced otherwise that as specifically described herein.

1. A fixing apparatus comprising:
an electrical condenser charged by a commercial power source;
a heat generating member configured to generate heat when the electrical condenser supplies power;
a fixing device heated by the heat generating member and configured to fix an image onto a recording medium;
a temperature switch activated when temperature of the fixing member reaches a prescribed abnormal level;
a power supply circuit configured to convey the power from the electrical condenser to the heat generating member; and
a cutting off device configured to cut off the power supply circuit when the temperature switch is operated.

2. A fixing apparatus comprising:
a first heat generating member configured to generate heat when AC power is supplied by a commercial power source;
an electrical condenser charged by the commercial power source;
a second heat generating member configured to generate heat when the electrical condenser supplies DC power;
a fixing member heated by the first and second heat generating members and configured to heat and fix an image onto a recording medium;
a first power supply circuit configured to convey AC power from the commercial power source to the first heat generating member;
a second power supply circuit configured to convey DC power from the electrical condenser to the second heat generating member; and
a first cutting off device configured to cut off the first power supply circuit when the temperature switch is operated.

3. The fixing apparatus according to claim 2, further comprising a second cutting off device configured to cut off the second power supply circuit when the temperature switch is operated.

4. The fixing apparatus according to claim 1, further comprising: a closed circuit including the cutting off device; and
a power source connected to the temperature switch, power of said power source being smaller than that of the electrical condenser.

5. The fixing apparatus according to claim 2, wherein said temperature switch includes one of a temperature fuse and a thermostat (TM), wherein said cutting off device includes a relay arranged between one of the commercial power source and the electrical condenser and the heat generating member, and wherein said relay is activated when one of the temperature fuse and thermostat is operated.

6. The fixing apparatus according to claim 4, wherein said smaller power source provides one of direct and alternate currents.

7. An image forming system including the fixing apparatus as claimed in claim 5.
